(19) United States
(12) Patent Application Publication
(10) Pub. No.: US 2022/0415081 A1
(43) Pub. Date: Dec. 29, 2022

(54) IMAGE MODIFICATION METHOD AND IMAGE MODIFICATION DEVICE

(71) Applicant: PEGATRON CORPORATION, Taipei City (TW)

(72) Inventors: Po-Sen Chen, Taipei City (TW); Chia-Liang Chiang, Taipei City (TW); Ching-Hao Yu, Taipei City (TW); Tsai-Chien Kao, Taipei City (TW); Cyuan-Yue Jhong, Taipei City (TW); Tao-Hua Cheng, Taipei City (TW)

(73) Assignee: PEGATRON CORPORATION, TAIPEI CITY (TW)

(21) Appl. No.: 17/727,671

(22) Filed: Apr. 22, 2022

(30) Foreign Application Priority Data
Jun. 24, 2021 (TW) 110123209

(51) Int. Cl. G06V 40/16; G06T 7/90; G06V 10/82

(52) U.S. Cl. CPC G06V 40/161; G06T 7/90; G06V 10/82; G06T 2207/20084; G06T 2207/30201

(57) ABSTRACT

An image modification method and an image modification device are disclosed. The method includes the following. A first image is obtained. A first image region in the first image and a second image region within the first image region are detected by at least one image detector. The second image region includes an image region presenting a target color in the first image region. The first image region is covered with a replacement image and a second image is generated based on an area ratio of the second image region to the first image region being greater than a predetermined value.

### CROSS-REFERENCE TO RELATED APPLICATION

This application claims the priority benefit of Taiwanese application no. 110123209, filed on Jun. 24, 2021. The entirety of the above-mentioned patent application is hereby incorporated by reference herein and made a part of this specification.

### BACKGROUND

### Technical Field

The disclosure relates to an image modification technology. In particular, the disclosure relates to an image modification method and an image modification device.

### Description of Related Art

With the advancement of technology and changes in living habits of people, distance teaching, online conferences, and other life modes of achieving contact between people through remote video connection are increasingly popularized. However, during remote video, a user may dress casually at home, be naked, or fail to notice that the camera lens is turned on, resulting in an indecent image including a naked body image of the user may be directly broadcasted by the remote video, thus causing troubles in use.

### SUMMARY

The disclosure provides an image modification method and an image modification device, in which accidental broadcasting of an indecent image can be effectively reduced.

An embodiment of the disclosure provides an image modification method, which includes the following. A first image is obtained. A first image region in the first image and a second image region within the first image region are detected by at least one image detector. The second image region includes an image region presenting a target color in the first image region. The first image region is covered with a replacement image and a second image is generated based on an area ratio of the second image region to the first image region being greater than a predetermined value.

An embodiment of the disclosure also provides an image modification device, which includes a storage circuit and a processor. The storage circuit is configured to store a first image and a second image and includes at least one image detector. The processor is coupled to the storage circuit and configured to execute the at least one image detector to detect a first image region in the first image and a second image region within the first image region. The second image region includes an image region presenting a target color in the first image region. The processor is also configured to cover the first image region with a replacement image and generate the second image based on an area ratio of the second image region to the first image region being greater than a predetermined value.

Based on the foregoing, after the first image is obtained, the first image region in the first image and the second image region having the target color may be detected by the at least one image detector. Next, it may be determined whether the region having the target color in the first image is too large according to the area ratio of the second image region to the first image region. If the region is too large, the image is determined to be an indecent image, and the first image region is covered with the replacement image to generate the second image. Accordingly, accidental broadcasting of an indecent image can be effectively reduced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic diagram of an image modification device according to an embodiment of the disclosure.

FIG. 1B is a schematic diagram of generating a second image according to a first image according to an embodiment of the disclosure.

FIG. 1C is a schematic diagram of generating a second image according to a first image according to an embodiment of the disclosure.

FIG. 2 is a schematic diagram of a user operating an image modification device according to an embodiment of the disclosure.

FIG. 3 is a schematic diagram of a first image according to an embodiment of the disclosure.

FIG. 4 is a schematic diagram of a first image region and a second image region according to an embodiment of the disclosure.

FIG. 5 is a schematic diagram of a second image according to an embodiment of the disclosure.

FIG. 6 is a schematic diagram of a video interface according to an embodiment of the disclosure.

FIG. 7 is a schematic diagram of a second image according to an embodiment of the disclosure.

FIG. 8 is a flowchart of an image modification method according to an embodiment of the disclosure.

FIG. 9 is a flowchart of an image modification method according to an embodiment of the disclosure.

### DESCRIPTION OF THE EMBODIMENTS

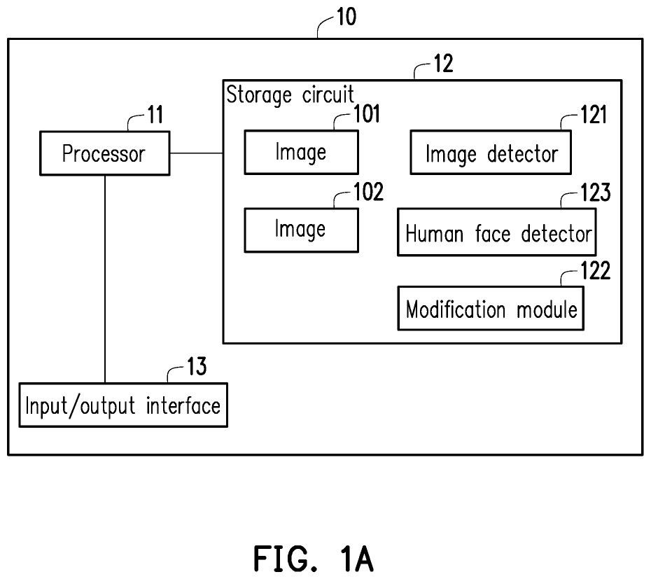

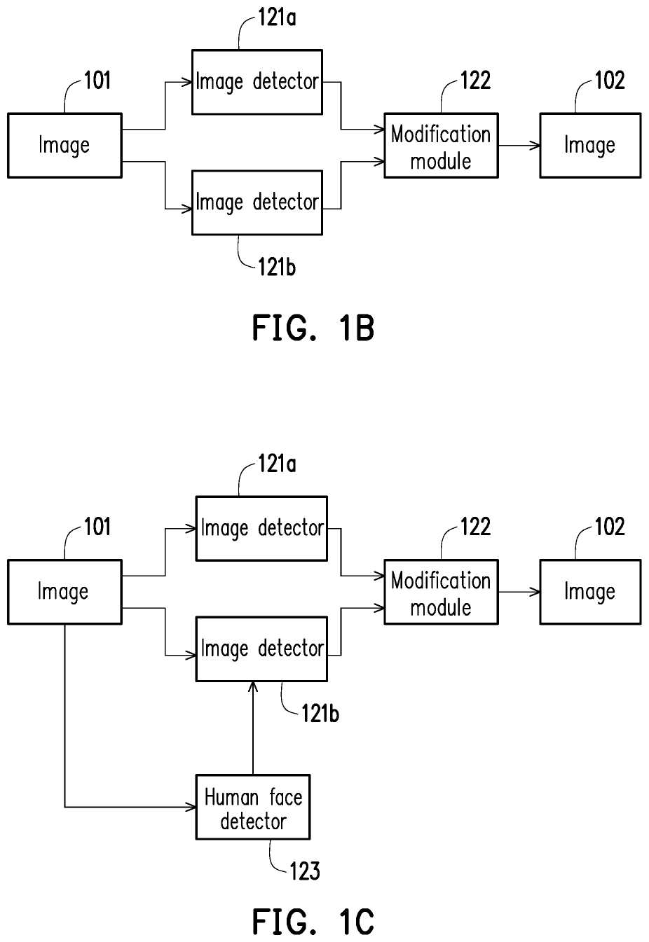

FIG. 1A is a schematic diagram of an image modification device according to an embodiment of the disclosure. With reference to FIG. 1A, an image modification device 10 may include various video devices, such as smart phones, notebook computers, desktop computers, tablet computers, or game consoles, or computer devices used with the video devices.

The image modification device 10 includes a processor 11, a storage circuit 12, and an input/output interface 13. The processor 11 is configured to be responsible for the whole or partial operation of the image modification device 10. For example, the processor 11 may include a central processing unit (CPU) or other programmable general-purpose or special-purpose microprocessors, digital signal processors (DSP), programmable controllers, application specific integrated circuits (ASIC), programmable logic devices (PLD), or other similar devices or a combination of these devices.

The storage circuit 12 is coupled to the processor 11 and configured to store data. For example, the storage circuit 12 may include a volatile storage circuit and a non-volatile storage circuit. The volatile storage circuit is configured for volatile storage of data. For example, the volatile storage circuit may include random access memory (RAM) or similar volatile storage media. The non-volatile storage circuit is configured for non-volatile storage of data. For example, the non-volatile storage circuits may include read only memory (ROM), a solid state disk (SSD), and/or a conventional hard disk drive (HDD), or similar non-volatile storage media.

The input/output interface 13 is coupled to the processor 11 and configured to perform signal input and output. For example, the input/output interface 13 may include various input/output devices, such as a network interface card, a display device, a mouse, a keyboard, a touch panel, a touch screen, a loudspeaker, a microphone, and/or a camera module. The type of the input/output device are not limited by the disclosure.

In an embodiment, the processor 11 may obtain an image (also referred to as a first image) 101 and stores the image 101 in the storage circuit 12. In an embodiment, the image 101 may be obtained from shooting an external image by a camera module (including a lens and a photosensitive element) in the input/output interface 13. Alternatively, in an embodiment, the image 101 may also be obtained by downloading from other electronic devices or servers.

In an embodiment, the processor 11 may execute an image detector 121 in the storage circuit 12 to analyze the image 101. For example, the image detector 121 may include a deep learning model and/or a neural network model. The deep learning model and/or the neural network model may be trained to improve detection efficiency (e.g., detection accuracy) for a specific object. In an embodiment, the processor 11 may detect at least one image region (also referred to as a first image region) in the image 101 and a specific image region (also referred to as a second image region) within the first image region by the image detector 121.

To be specific, the processor 11 may execute the image detector 121 to detect a specific object (i.e., the first image region and the second image region) in the image 101. The image detector 121 may feed the detection result for the specific object back to the processor 11.

In an embodiment, the processor 11 may execute a modification module 122 in the storage circuit 12 to perform image modification on the image 101. In an embodiment, the processor 11 may cover the first image region with a replacement image and generate the image 102 by the modification module 122 based on an area ratio of the second image region to the first image region detected by the image detector 121. Accordingly, in an image 102, at least part of the image in the first image region may be masked (i.e., covered) by the replacement image. The image 102 may be stored in the storage circuit 12 and be output by the input/output interface 13 (e.g., a display and/or a network interface card).

In an embodiment, the first image region includes an image region presenting a specific human body part (also referred to as a target human body part) in the image 101. In an embodiment, the target human body part may include the part generally considered to be the location of sexual organs of a human body or surroundings of the part. For example, the target human body part may include at least one of a breast, a crotch, and a hip of the human body. In other embodiments, the target human body part may also include any part of a human body that may discomfort or displease viewers when not being hidden by clothing, such as a thigh or a calf of a human body, which is not limited by the disclosure.

In an embodiment, the second image region includes at least part of an image region presenting a specific color (also referred to as a target color) in the first image region. For example, the target color may include a skin color of the human body presented in the image 101. As a race of the user, a skin condition of the user, and/or an ambient light differ, the target color may also change accordingly. In an embodiment, the processor 11 may determine the target color according to a color (i.e., the skin color) of a human face in the image 101.

FIG. 1B is a schematic diagram of generating a second image according to a first image according to an embodiment of the disclosure. With reference to FIG. 1B, in an embodiment, the image detector 121 in FIG. 1A includes an image detector 121a (also referred to as a first image detector) and an image detector 121b (also referred to as a second image detector). The image 101 may be input via different channels to the image detectors 121a and 121b.

After the image 101 is input to the image detector 121a, the image detector 121a may analyze the 101 image to detect the first image region in the image 101, for example, detect the image region presenting the target human body part in the image 101. In an embodiment, the image detector 121a may frame the image region presenting the target human body part in the image 101. The image region framed by the image detector 121a is namely the first image region.

In addition, after the image 101 is input to the image detector 121b, the image detector 121b may analyze the image 101 to detect the second image region within the first image region in the image 101, for example, detect the image region presenting the target color in the image 101.

It should be noted that, in another embodiment, the input of the image detector 121b may also be connected in series to the output of the image detector 121a. Accordingly, after the image detector 121a detects the first image region in the image 101, the image detector 121b may further detect the second image region in the first image region based on the first image region detected by the image detector 121a.

In an embodiment, the image detector 121a and the image detector 121b each include a deep learning model and/or a neural network model. To be specific, the image detector 121a may be trained by a great number of first sample images to enable the trained image detector 121a to detect the first image region in the image 101. Each of the first sample images includes the first image region that has been labeled as the target human body part. The image detector 121b may be trained by a great number of second sample images to enable the trained image detector 121b to detect the second image region in the image 101. Each of the second sample images includes the second image region that has been labeled as the target color.

After the first image region and the second image region are detected, the processor 11 may execute the modification module 122 of the storage circuit 12 to analyze the area ratio of the second image region to the first image region. Based on the area ratio, the processor 11 may cover the first image region with a replacement image to modify the image 101 and generate the image 102.

In an embodiment, the modification module 122 may determine whether to modify the image 101 (e.g., cover the first image region with the replacement image) according to whether the area ratio of the second image region to the first image region is greater than a predetermined value. In an embodiment, the modification module 122 may obtain the area of the first image region according to the output of the image detector 121a and obtain the area of the second image region according to the output of the image detector 121b. The modification module 122 may determine whether the proportion of the area of the second image region in the area of the first image region is greater than a predetermined value. The predetermined value may be a positive value not greater than 1, such as 20% to 100%. If the proportion of the area of the second image region in the area of the first image region is greater than the predetermined value, that is, the skin color occupies a great area in the first image region and there may be an indecent image, the modification module 122 may therefore modify the image 101 (i.e., cover the first image region with the replacement image) to replace the possibly existing indecent image. However, if the proportion of the area of the second image region in the area of the first image region is not greater than the predetermined value, the modification module 122 may not modify the image 101.

With reference back to FIG. 1A, in an embodiment, the processor 11 may also operate a human face detector 123 in the storage circuit 12 to perform human face detection or human face recognition on the image 101. In an embodiment, the processor 11 may detect the human face in the image 101 by the human face detector 123. The processor 11 may determine the target color according to the color of the human face. Accordingly, the target color for detecting the second image region may be determined instantly and/or dynamically according to the current image 101.

FIG. 1C is a schematic diagram of generating a second image according to a first image according to an embodiment of the disclosure. With reference to FIG. 1C, in an embodiment, the image 101 may also be input to the human face detector 123. The human face detector 123 may analyze the image 101 to detect a human face presented in the image 101 through human face detection technology or face recognition technology. According to the human face detected by the human face detector 123, the image detector 121b may determine the target color according to the (main) color of the image region where the human face is located in the image 101 (i.e., the color of the human face in the image 101). According to the target color, the image detector 121b may detect the second image region in the image 101.

In an embodiment, according to the color of the human face (i.e., the skin color) in the image 101 detected by the human face detector 123, the processor 11 may select at least one image detection model (also referred to as a target model) from a plurality of candidate models for use by the image detector 121a and/or the image detector 121b. Accordingly, in response to differences in the race of the user, the skin condition of the user, and/or the ambient light, the image detector 121a and/or the image detector 121b may dynamically adopt an appropriate image detection model to improve detection efficiency for the first image region and/or the second image region.

In an embodiment, the image 102 generated by modifying the image 101 may include a local image and a remote image. The local image may be presented by the display of the input/output interface 13. The remote image may be transmitted to a remote device by using the network interface card of the input/output interface 13. In an embodiment, the processor 11 may present a warning message as the replacement image in the local image to warn or remind the user that there is an indecent image in the original image 101 and part of the image has been masked or covered. The processor 11 may present replacement clothes as the replacement image in the remote image. The image of the replacement clothes may be configured to mask part of the image in the original image 101, namely part of the image in the first image region.

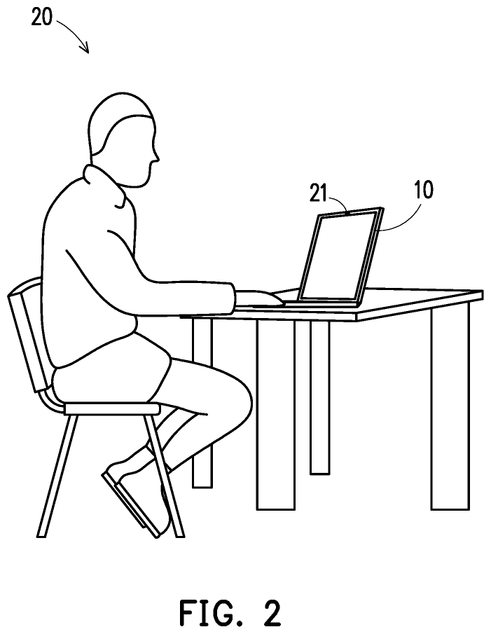

FIG. 2 is a schematic diagram of a user operating an image modification device according to an embodiment of the disclosure. With reference to FIG. 2, it is assumed that a user (also referred to as a local user) 20 is located in front of a lens 21 of the image modification device 10. The lens 21 may be included in the input/output device 13 of FIG. ito capture an image (i.e., the first image) of the user 20. It should be noted that although a notebook computer is taken as an example of the image modification device 10 in the embodiment of FIG. 2, in other embodiments, the image modification device 10 may also be various video devices, such as smart phones, desktop computers, tablet computers, or game consoles, or computer devices used in conjunction with the video devices, which is not limited by the disclosure.

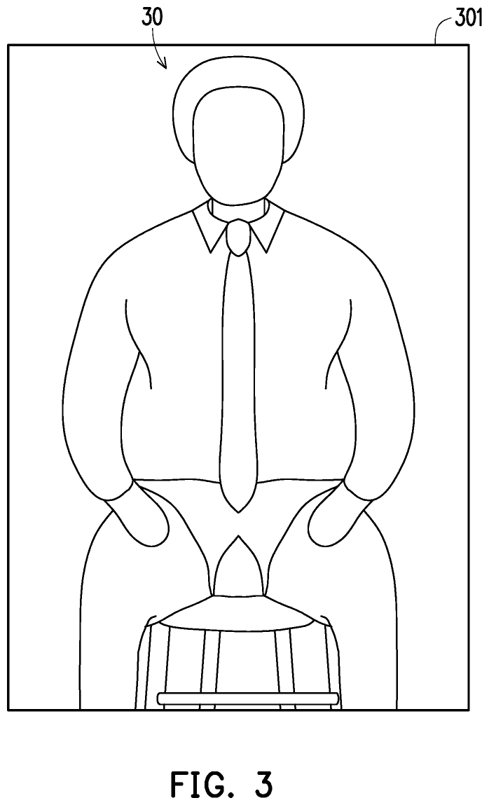

FIG. 3 is a schematic diagram of a first image according to an embodiment of the disclosure. With reference to FIG. 3, following the embodiment of FIG. 2, it is assumed that the image 101 (i.e., first image) of FIG. 1 includes an image 301. The image 301 may present a user image 30.

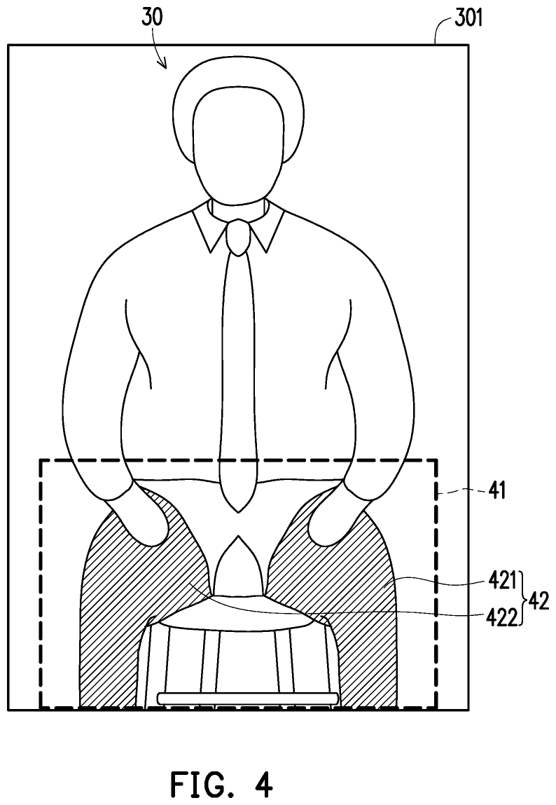

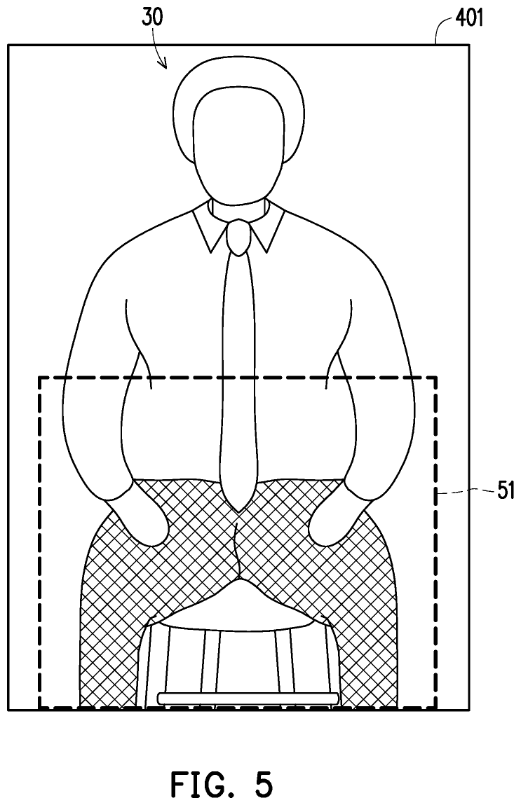

FIG. 4 is a schematic diagram of a first image region and a second image region according to an embodiment of the disclosure. With reference to FIG. 4, following the embodiment of FIG. 3, an image region 41 (i.e., the first image region) and an image region 42 (i.e., the second image region) in the image 301 may be detected. For example, the image region 41 may contain a crotch, that is, an image range of the target human body part, in the user image 30. In addition, the image region 42 may include image regions 421 and 422, that is, image regions of naked thighs and/or calves in the user image 30. The image regions 421 and 422 may contain an image region presenting a skin color (i.e., a target color) in the image region 41.

FIG. 5 is a schematic diagram of a second image according to an embodiment of the disclosure. With reference to FIG. 5, following the embodiment of FIG. 4, according to an area ratio of the image region 42 to the image region 41 (for example, the proportion of the area of the image region 42 in the area of the image region 41 being greater than the predetermined value), the image region 41 may be covered with a replacement image 51 to modify an indecent image for the original image 301. For example, after the replacement image 51 is used to cover at least part of the image region 41, the indecent part or the naked part in the original image 301 may be masked. For example, the replacement image 51 may present the replacement clothes for masking the indecent image. The image 401 (i.e., the second image) may be generated according to the modified image 301. In an embodiment, the image 401 may be transmitted to the remote device as a remote image for display. In addition, in an embodiment, the image 401 may also be presented by the display of the image modification device 10 as a local image.

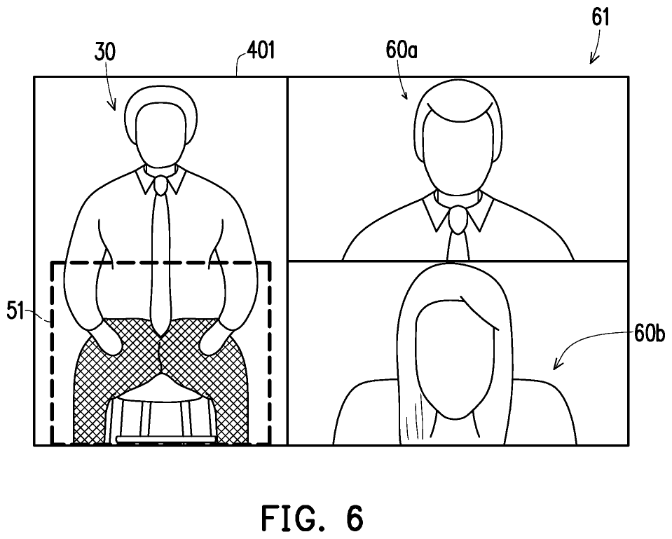

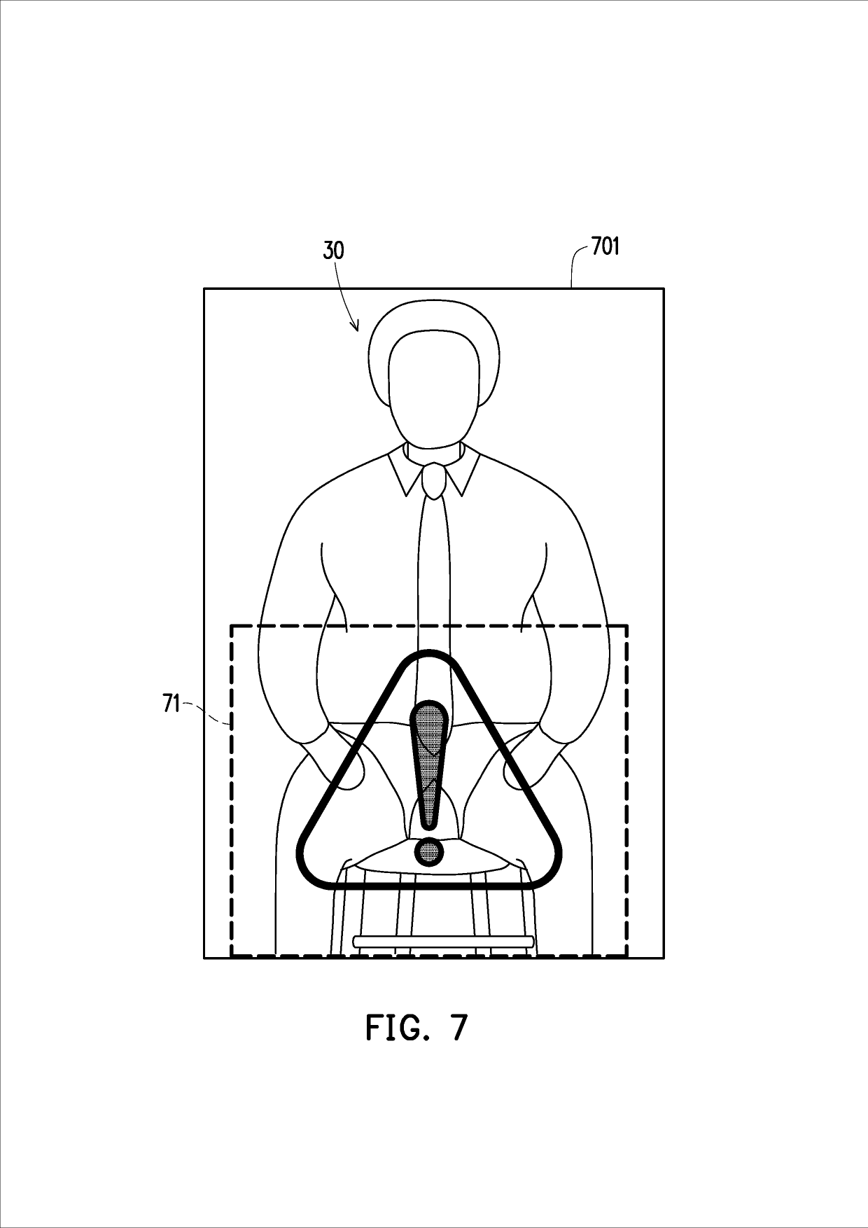

FIG. 6 is a schematic diagram of a video interface according to an embodiment of the disclosure. With reference to FIG. 6, following the embodiment of FIG. 5, during remote video, a video interface 61 may be presented on the display of the image modification device 10 and/or the display of the remote device. User images 30, 60a, and 60b may be presented in the video interface 61. The user image 30 is an image of the user 20 in FIG. 2. The user images 60a and 60b are images of multiple remote users. Compared with the original image 301, presenting the modified image 401 in the video interface 61 can prevent an indecent image including a naked body image of the user from being directly broadcast by the remote video.

FIG. 7 is a schematic diagram of a second image according to an embodiment of the disclosure. With reference to FIG. 7, following the embodiment of FIG. 4, an image 701 may be included in the second image and may serve as a local image. According to the area ratio of the image region 42 to the image region 41 (for example, the proportion of the area of the image region 42 in the area of the image region 41 being greater than the predetermined value), the image region 41 may be covered with a replacement image 71. It should be noted that, compared with the replacement image 51 of FIG. 5 and FIG. 6, a warning message may be displayed in the replacement image 71. The warning message may be configured to warn or remind the local user that there is an indecent image in the original image 101 and part of the image has been masked or covered.

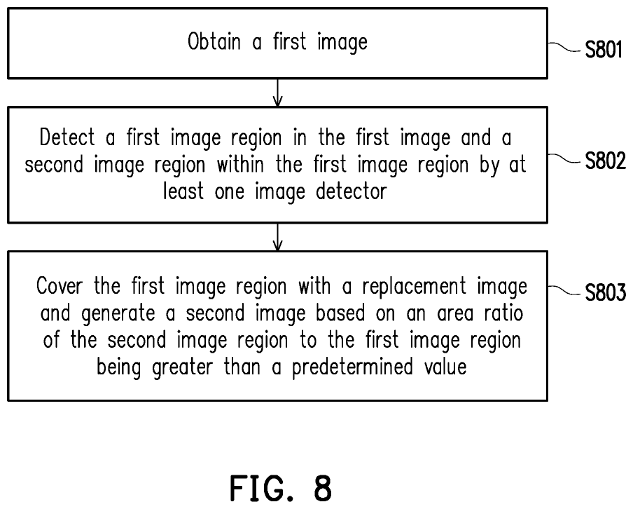

FIG. 8 is a flowchart of an image modification method according to an embodiment of the disclosure. With reference to FIG. 8, in step S801, a first image is obtained. In step S802, a first image region in the first image and a second image region within the first image region are detected by at least one image detector. In step S803, the first image region is covered with a replacement image and a second image is generated based on an area ratio of the second image region to the first image region being greater than a predetermined value.

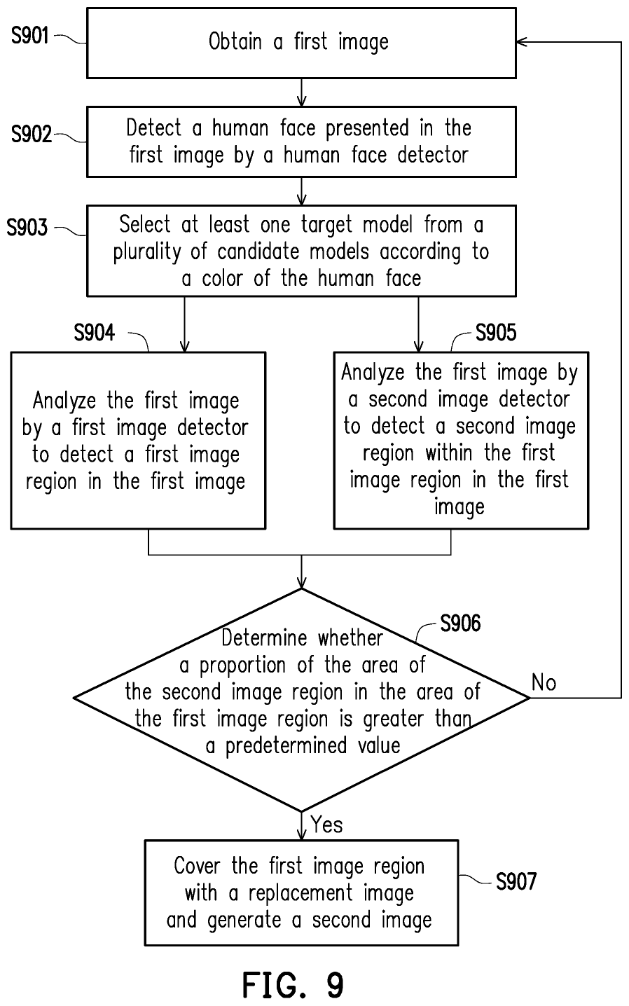

FIG. 9 is a flowchart of an image modification method according to an embodiment of the disclosure. With reference to FIG. 9, in step S901, a first image is obtained. In step S902, a human face presented in the first image is detected by a human face detector. In step S903, at least one target model is selected from a plurality of candidate models according to a color of the human face. In step S904, the first image is analyzed by a first image detector to detect a first image region in the first image. In step S905, the first image is analyzed by a second image detector to detect a second image region within the first image region in the first image.

In step S906, it is determined whether a proportion of the area of the second image region in the area of the first image region is greater than a predetermined value. If it is determined to be Yes, in step S907, the first image region is covered with a replacement image and a second image is generated. Accordingly, in the second image, at least part of the image in the first image region may be masked (i.e., covered) with the replacement image. In addition, if it is determined to be NO in step S906, the flow may return to step S901.

Each step in FIG. 9 has been described in detail as above, and will not be repeatedly described here. It is worth noting that each step in FIG. 9 may be implemented as multiple programming codes or circuits, which is not limited by the disclosure. In addition, the method of FIG. 9 may be used in conjunction with the above exemplary embodiments, and may also be used alone, which is not limited by the disclosure.

In summary of the foregoing, according to the exemplary embodiments of the disclosure, an indecent image in a (video) image may be dynamically detected. If there is an indecent image, the indecent image may be instantly masked with a replacement image. Accordingly, accidental broadcasting of an indecent image can be effectively reduced.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An image modification method, comprising:
obtaining a first image;
detecting a first image region in the first image and a second image region within the first image region by at least one image detector, wherein the second image region comprises an image region presenting a target color in the first image region; and
covering the first image region with a replacement image and generating a second image based on an area ratio of the second image region to the first image region being greater than a predetermined value.

2. The image modification method according to claim 1, wherein the first image region comprises an image region presenting a target human body part in the first image.

3. The image modification method according to claim 2, wherein the target human body part comprises at least one of a breast, a crotch, and a hip of a human body.

4. The image modification method according to claim 1, wherein the target color comprises a skin color of a human body presented in the first image.

5. The image modification method according to claim 1, wherein the step of detecting the first image region in the first image and the second image region within the first image region comprises:
detecting a human face presented in the first image; and
determining the target color according to a color of the human face.

6. The image modification method according to claim 1, wherein the at least one image detector comprises a first image detector and a second image detector, and the step of detecting the first image region in the first image and the second image region within the first image region by the at least one image detector comprises:
detecting the first image region in the first image by the first image detector; and
detecting the second image region within the first image region in the first image by the second image detector.

7. The image modification method according to claim 1, wherein the second image comprises a local image and a remote image, and the image modification method further comprises:
presenting a warning message as the replacement image in the local image; and
presenting replacement clothes as the replacement image in the remote image.

8. An image modification device, comprising:
a storage circuit configured to store a first image and a second image and comprising at least one image detector; and
a processor coupled to the storage circuit, and configured to:
execute the at least one image detector to detect a first image region in the first image and a second image region within the first image region, wherein the second image region comprises an image region presenting a target color in the first image region; and
cover the first image region with a replacement image and generate the second image based on an area ratio of the second image region to the first image region being greater than a predetermined value.

9. The image modification device according to claim 8, wherein the at least one image detector comprises a deep learning model or a neural network model.

10. The image modification device according to claim 8, wherein the first image region comprises an image region presenting a target human body part in the first image.

11. The image modification device according to claim 10, wherein the target human body part comprises at least one of a breast, a crotch, and a hip of a human body.

12. The image modification device according to claim 8, wherein the target color comprises a skin color of a human body presented in the first image.

13. The image modification device according to claim 8, wherein the processor is further configured to:
execute the at least one image detector to detect a human face presented in the first image; and
determine the target color according to a color of the human face.

14. The image modification device according to claim 8, wherein the at least one image detector comprises a first image detector and a second image detector, and the operation of the processor executing the at least one image detector to detect the first image region in the first image and the second image region within the first image region comprises:
execute the first image detector to detect the first image region in the first image; and
execute the second image detector to detect the second image region in the first image.

15. The image modification device according to claim 8, wherein the storage circuit is further configured to store a plurality of candidate models and comprises a human face detector, and the processor is further configured to:
execute the human face detector to detect a human face presented in the first image; and
select at least one target model from the candidate models according to a color of the human face, and provide the at least one image detector with the at least one target model for use.

16. The image modification device according to claim 8, wherein the second image comprises a local image and a remote image, and the processor is further configured to:
present a warning message as the replacement image in the local image; and
present replacement clothes as the replacement image in the remote image.
